(19) United States
(12) Patent Application Publication
(10) Pub. No.: US 2008/0208912 A1
(43) Pub. Date: Aug. 28, 2008

(54) SYSTEM AND METHOD FOR PROVIDING CONTEXTUALLY RELEVANT MEDICAL INFORMATION

(76) Inventor: Jeffrey M. Garibaldi, St. Louis, MO (US)

Correspondence Address: Kevin Pumm, Suite 400, 7700 Bonhomme, St. Louis, MO, 63105, US

(21) Appl. No.: 12/033,312

(22) Filed: Feb. 19, 2008

Related U.S. Application Data
(60) Provisional application No. 60/891,661, filed on Feb. 26, 2007.

(51) Int. Cl. G06Q 50/00; G06F 7/00

(52) U.S. Cl. 707/104.1; 705/3

(57) ABSTRACT

A system and method for the real-time presentation of context-relevant information to a user of a medical intervention system is disclosed. Embodiments of the invention provide for the definition of a current system context, analysis of the current system context, generation of a search parameter set, search of a set of information sources, analysis of the search results, and presentation to the user. The context-relevant information is updated as the intervention proceeds.

### CROSS-REFERENCE APPLICATION

This application claims priority to prior U.S. Provisional Patent Application No. 60/891,661, filed Feb. 26, 2007, the entire disclosure of which is incorporated herein by reference.

### BACKGROUND

This invention relates to methods and systems for a medical intervention information system, the system automatically searching for and providing contextually relevant medical information to a user of an interventional medical system. In particular, data relating to the current context of the system, for example, regarding the current state of an interventional medical system, patient data, and data based on previously entered user preferences are analyzed to define a context that is relied upon to perform information sources searches and to present to the user the most relevant information.

Minimally invasive intervention systems include navigation systems, such as the Niobe™ magnetic navigation system developed by Stereotaxis, St. Louis, Mo. Such systems typically comprise an imaging means for real-time guidance and monitoring of the intervention; additional feedback is provided by a three-dimensional (3D) localization system that allows real time determination of the catheter or interventional device tip position and orientation with respect to the operating room and, through co-registered imaging, with respect to the patient.

Minimally invasive interventions, including cardiac surgery, comprise several of the most complex medical interventions practiced today; as illustration, it is not uncommon for an electrophysiology diagnostic study and subsequent therapeutic treatment to last for several hours. While novel system design approaches, including the development of magnetic navigation, have significantly improved ease of procedure, lowered patient risks, and improved overall patient outcomes, the complexity of certain interventions, such as electrophysiology cardiac ablation, remains such that long intervention times are necessary and critical decisions have to be made without delay at numerous points during a procedure.

The background information that is relevant to the practice of minimally invasive surgery and to the remote navigation of endoluminal devices comprises a large universe of technologies, sciences, medical arts, regulations, and practices. The choice of approaches for a given situation, and the selection of associated devices, drugs, and therapeutic methods can be difficult even to the most experienced physicians. Additionally, the technologies enabling such complex interventions evolve at a rapid pace, and the amount of information available to a user even in the most specialized fields of cardiac surgery increases day-to-day in a way perhaps best described by an exponential model.

Database technologies, availability, and performance have increased in pace with the development of computer and information technologies over the last few decades. The emergence first of the internet and then in the 1990s of the world-wide-web (“web” thereafter) has spurred rapid growth in the amount and accessibility of available information. The Internet initially made remote databases and other sources of information available to a network of inter-connected computers. The web has made it possible to search in essentially “real-time” databases either non-resident on a local computer or resident on internet sites to which a computer is not otherwise directly connected to as part of a specific network.

### SUMMARY

The present invention relates to methods of gathering, analyzing, and presenting context-relevant information to users of specialized medical intervention systems such as endoluminal devices navigation systems.

More specifically this invention relates to methods and systems for a medical information system comprising context sensitive searching capability the system automatically searching for and providing contextually relevant medical information to a user of an interventional medical system. In particular, a search method is introduced that automatically gathers information to define a current medical system context, frequently updates the defined medical system context, processes the medical system context to define parameters in preparation for searching, performs searches on a set of information sources based at least in part on the processed system context, and presents to the user at least part of the search results.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings of preferred embodiments thereof, wherein:

FIG. 1-A is a schematic diagram showing a patient positioned in a projection imaging and interventional system for a minimally invasive procedure such as an electrophysiology diagnostic and therapeutic intervention;

FIG. 1-B schematically illustrates an interventional device distal end being navigated through the patient's heart to collect diagnostic information such as electrical activity in the left ventricle;

FIG. 1-C schematically presents a graphical user interface display showing a window with a listing of the current search parameter, a window with an ordered listing of search results, and a larger window displaying a larger extent of one of the references found by the search;

FIG. 2 presents a functional block diagram of a preferred embodiment of the present invention as applied to the interventional system of FIG. 1;

FIG. 3 presents an example of a search parameter form;

FIG. 4 describes a display presenting an ordered list of results;

FIG. 5 presents one of the reference found by the search with one of the search parameter form fields highlighted;

FIG. 6 presents a flow chart of a preferred method embodiment of the present invention as applied to the interventional system of FIG. 1; and

FIG. 7 illustrates a display according to one embodiment of the present invention applied to cardiac resynchronization therapy (CRT).

Corresponding reference numerals indicate corresponding parts throughout the several views of the drawings.

### DETAILED DESCRIPTION

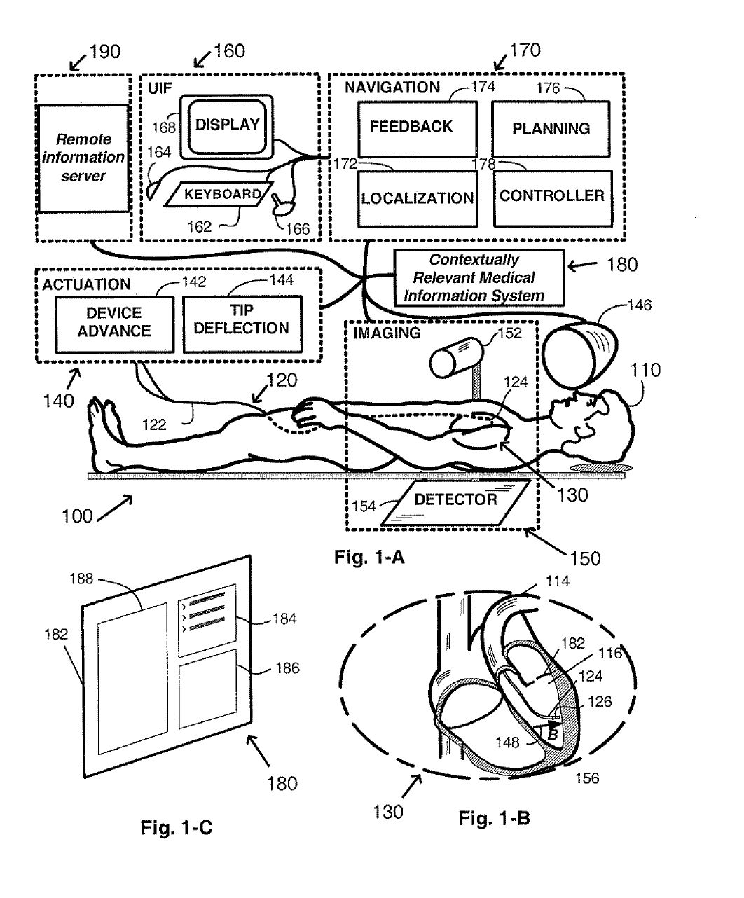

As illustrated in FIG. 1-A, a patient 110 is positioned within a remotely actuated, computer controlled interventional system 100. An elongated navigable medical device 120 having a proximal end 122 and a distal end 124 is provided for use in the interventional system 100 and the medical device is inserted into a blood vessel of the patient and navigated to an intervention volume 130. A means of applying force or torque to advance or orient the device distal end 124 is provided, as illustrated by actuation block 140 comprising a component 142 capable of precise device advance and retraction and a tip deflection component 144. The actuation system for tip deflection may be one of (i) a mechanical pull-wire system; (ii) a hydraulic or pneumatic system; (iii) an electrostrictive system; (iv) a magnetostrictive system; (v) a magnetic system; or (vi) other navigation system as known in the art.

For illustration of a preferred embodiment, in magnetic navigation a magnetic field 148 externally generated by magnet(s) assembly 146 orients a small magnetically responsive element 126 (FIG. 1-B) located at or near the device distal end 124. Real time information is provided to the physician by an imaging sub-system 150, for example an x-ray imaging chain comprising an x-ray tube 152 and a digital x-ray detector 154, to facilitate planning and guidance of the procedure. Additional real-time information such as distal tip position and orientation may be supplied by use of a three-dimensional (3D) device localization sub-system such as comprising a set of electromagnetic wave receivers located at the device distal end (not shown), and associated external electromagnetic wave emitters (not shown); or other localization device with similar effect such as an electric field-based localization system that measures local fields induced by an externally applied voltage gradient. In the latter case the conducting body of a wire within the device itself carries the signal recorded by the tip electrode to a proximally located localization system.

The physician provides inputs to the navigation system through a user interface (UIF) sub-system 160 comprising user interfaces devices such as keyboard 162, mouse 164, joystick 166, display 168, and similar input devices. Display 168 also shows real-time image information acquired by the imaging system 150 and localization information acquired by the three-dimensional localization system. UIF sub-system 160 relays inputs from the user to a navigation sub-system 170 comprising 3D localization block 172, feedback block 174, planning block 176, and controller 178. Navigation control sequences are determined by the planning block 176 based on inputs from the user, and also possibly determined from pre-operative or intra-operative image data and localization data from a localization device and sub-system as described above and processed by localization block 172, and alternatively or additionally real-time imaging or additional feedback data processed by feedback block 174. The navigation control sequence instructions are then sent to controller 178 that actuates interventional device 120 through actuation block 140 to effect device advance or retraction and tip deflection.

Other navigation sensors might include an ultrasound device or other device appropriate for the determination of distances from the device tip to surrounding tissues, or for tissue characterization. Further device tip feedback data may include relative tip and tissues positions information provided by a local intra-operative imaging system, and predictive device modeling and representation. Such device feedback in particular enables remote control of the intervention. In closed-loop implementations, the navigation sub-system 170 automatically provides input commands to the device advance/retraction 142 and tip orientation 144 actuation components based on feedback data and previously provided input instructions; in semi closed-loop implementations, the physician fine-tunes the navigation control, based in part upon displayed information and possibly other feedback data, such as haptic force feedback feel. Control commands and feedback data may be communicated from the user interface 160 and navigation sub-system 170 to the device and from the device back to navigation sub-system 170 and the user through cables or other means, such as wireless communications and interfaces. Additionally, FIG. 1.A schematically shows a remote information server 190 that is connected to the information system 180 in specific embodiments of the present invention.

FIG. 1-B schematically shows the distal end 124 of interventional device 120 having progressed through the aorta 114 into the left ventricle 116. There the device distal end is magnetically navigated by an externally generated magnetic field B 148 toward a series of points on the tissues surfaces. In diagnostic operation, the device collects functional information such as electrical activity. As the device is localized in 3D through localization sub-system 172, the location and orientation of the distal end 124 can be co-registered to 3D anatomical image information, as for example acquired by a rotating x-ray fluoroscopy image chain 150 or by a CT system (not shown). In such a manner, and for illustration of a typical cardiac ablation application, after completion of cardiac chamber activity mapping, diagnostic information co-registered to 3D pre-operative or intra-operative image data is immediately available to navigation system 170 to automatically advance the interventional device to a series of points for ablative therapy, as determined either by the user or automatically by the navigation system based on prior user inputs. In many cases however the device and device distal tip are shown only in a projection image sequence, such as acquired by a fluoroscopy system 150, and intra-operative 3D image data are not readily available in co-registration with the projection image(s); it is then common practice to register the fluoroscopy or projection image sequence to a pre-operative 3D image data set.

In the context of this preferred embodiment of this invention, the term “information sources” denotes a set of sources that can include database(s) resident on the medical system; remote databases, located either on an intranet to which the medical system is connected, or on web-accessible remote sites; and the set of information available on the web. Thus “information sources” defines a superset of the world-wide-web comprising specific internet sites that may not be publicly accessible and that contain relevant information for the guidance of minimally invasive interventional medical procedures.

FIG. 1-C shows a display 182 part of contextually relevant medical information system block 180, that may be the same as display 168 of UIF block 160 or maybe a separate, additional display, presenting an information search interface. In various embodiments, the functionality of block 180 may be distributed among the various system blocks previously described. For example, software instructions to generate a current system context may run on a computer part of navigation block 170, and search results and associated data maybe presented to the user on display 168 part of UIF block 160. Many configuration variations are possible and depend on overall interventional medical system design. Alternatively, information system 180 may be resident on a computer separate from but connected to medical interventional system 100. In one embodiment of the present invention, monitor 182 displays information on three windows: search window 184 presents the search parameters as well as the recent search history; window 186 shows the first search results as ordered by relevance; and window 188 presents in more details and extent one of the references either automatically selected from the search result list or user selected, the user for example clicking on the corresponding search result line(s) to select the reference.

System context can also encompass prior interventions when such interventions are relevant to the present intervention, as is the case for example when a user history of preferences is built and learnt by the system over several sessions; other situations where past procedures are also relevant do arise. Defining the system context comprises analyzing the history series of system states representative of the system configuration through time. The system context takes into account the procedure type; intervention time; type of catheter, guide wire, sheath, and/or medical devices used during the procedure; number of attempts at effecting navigation through anatomy such as a branch or occlusion; anatomy traversing or occlusion crossing time; proximal applied forces time series; applied magnetic field time series, and similar navigation data.

System context can also include patient information, such as medical records, medical history, images, and data from previous examinations and related diagnostic records, and other patient data as maybe available in the context of interventional medicine. Further inputs to the system context generator can include the result of processing applied to data collected during the procedure, or processed data made available to the system and user prior to the procedure that are of relevance to the intervention. Additionally system context can also comprise processing data acquired during the intervention, either at a remotely located central information server denoted by 190 in FIG. 1-A, or on the information system computer. Examples of acquired and possibly processed data include an ECG data set, a medical image data set, an electrical activity data set, a vital set data set, blood pressure information, an oximetry data set, and generally speaking information that is measured or measurable during an interventional procedure as known in the art. Such data also include local and or internal ECG and electrical activity data, including reference activity or ECG data; ultrasound cardiac data acquired for example via a probe inserted through the esophagus; and other relevant interventional data. The system context generator accounts for entered user preferences, and learns the user preferences over time, so as to enable a determination of applicable preferences to a given intervention and a given user, without the user having to re-enter such data.

Accordingly, block 210 takes as input procedure data 212, and analyzes these data to generate an output data set 214. It is noted that the procedure analysis block 210 may also comprise sending collected data to a remote site for automatic or semi-automatic analysis; the results of this remote analysis being sent back to block 210 for further processing. Block 220 analyzes the history of command and data inputs 222 for the procedure or intervention under consideration, and generates output data set 224. Block 230 processes the available history of user preferences 232 to adaptively learn preferences and fine-tune system responses based on learnt user preferences data 234. Similarly, block 240 analyzes patient data input 242 comprising image data, diagnostic records, and medical history and generates a patient information output data set 244. Output data sets 214, 224, 234, and 244 are then processed by block 246 that defines the intervention/procedure context. The processing performed by block 246 comprises sorting data, scoring data for relevance to the present intervention, ranking data, and generating an output context definition.

The output of block 246 is a context definition that comprises information ranked or weighted as to relevance, in one embodiment a set of ranked categories. In this embodiment, a set of categories is pre-defined, subject to adaptive evolution, and available to the information system. A first decision made by block 246 is whether or not a given category taken from the pre-defined category set belongs to the context definition output; this determination being made by searching output data sets 214, 224, 234, and 244 for presence of this category as evidenced by associated category features. Then the collection of retained output categories defines a set of context features that are weighted and ranked in terms of importance and relevance to the current intervention. Categories and context features include not only text but also images, procedural information, as for example a series of procedure steps, diagnostic data such as ECG or electrical activity data typical of a condition, and similar. Further examples of context definition data include expected remaining intervention time; general or local anesthesia considerations; characterization of electrical activity; suggestion of therapeutic approaches based on characterized electrical activity; number of ablation points/lines yet remaining; typical device(s) to be used in the procedure; patient x-ray dose, expected dose throughout the remainder of the procedure, and relation to certain dose threshold such as likelihood of skin effects; and other such information as known in the art.

In practice, the system context is updated, either at regular time intervals, or upon specific input triggers such as a user command or action, or as the result of an automatic data monitoring or analysis prompt.

The current context data are then analyzed by context analyzer block 250 to generate a set of context-related search parameters 252 that facilitates searching for the most relevant intervention information. The context processing also can include sending data to a remote information server; the remote server then processes part or all of the context data, and leverages a central database of context information and search parameters to further define or optimize the search parameter output data, or to better characterize a set of context data; such parameter set or characterization information being then sent back to the information system. As previously described with respect to the generation of the context information, the remote processing can be entirely automatic, or can also leverage human inputs: highly specialized experts analyze and interpret the sent data to refine the search parameter definition. This interaction can include interpreting results of an analysis data performed on intra-operative data. The search parameter set, possibly comprising keywords, characterize the context and state of the intervention, and also attempts to anticipate next likely steps and associated clinical information such as known complications or previously encountered difficulties, and information streams of use in successfully carrying out the intervention, such as a series of typical therapeutic steps. In one embodiment, the parameters are organized in categories, taken from a pre-defined category master list. These retained parameter fields and their values or instantiations are part of the context analysis output. In one embodiment, generating the output search parameter set also includes calculating a relevance weight for each of the fields present in the output form. Such weights allow calculating a vector distance between a current system context and a search reference context, as described below.

The medical information system contains a specialized browser to perform searches and display the contextually relevant information during medical procedures or procedure reviews. The browser or search engine 260 takes as input the set of search parameters 252 previously defined. The medical system browser utilizes multiple sources of input in a medical situation to analyze and deliver the most contextually relevant information to the user of the system in the lab moment-by-moment. A browser interface is available as part of the information system to carry out searches; a search can be generic, as for example in a Google text search, or can be specific to a given database, or set of accessible databases. The contextually relevant information includes a plurality of information types including news briefs, case reviews, application notes, chat room, patents, patent applications, journal articles, presentation abstracts and summaries, books, marketing brochures, specification materials, internet pages, advertising, and other such information as known in the art. These types of information are termed “references” therein; a search reference is thus associated to an information type. Accordingly performing a search in a set of information sources comprises performing a search selected from the group consisting of a parameter search, a keyword search, and a feature search. The set of information sources includes local databases; remote databases; intranet web sites; web sites.

In specific embodiments of the invention, a central information server is connected to the medical information system through a real-time network, and information can be downloaded to the medical information system in real-time based upon updates to the central information server or changes to the medical system context. The browser searches are conducted either at regular time intervals or upon specific input triggers such as a user command or action, or a change in the current system context. The information system builds a history of searches and organizes the presented information to account for relevance priorities and user interactions with the presented results, so as to list first the most relevant references that have not yet been accessed on the output listing. It is noted that the information system of the present invention enables searching set(s) of information based on search parameter(s) of one or several types, and finding results containing another set of information types. As an example, a search can contain as a search parameter a keyword such as “CTO” (for chronic total occlusion) and an associated search result can contain as one of its fields a typical x-ray image of a CTO, or a three-dimensional surface representation of a CTO. Conversely, the search parameter set can include an ECG segment, and yield as a result a reference containing text, images, and graphics. Accordingly the search engine of the present invention enables “cross-type” searches. It is not necessary for either of the input/output images to have been analyzed for specific features, although such a situation frequently occurs in practice.

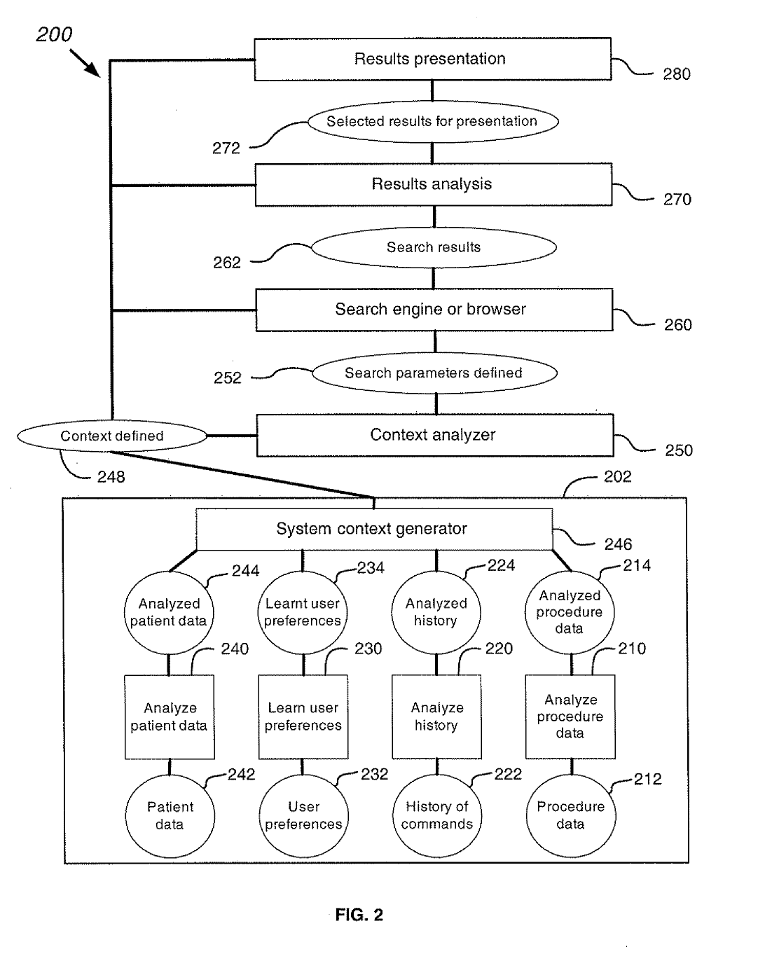

This step of building a search history is part of the results analysis 270. As illustrated in FIG. 2, the set of search results 262 is sent to the result analysis block 270 for sorting and weighting, the analysis being based at least in part on the previously defined system context 248. The analysis of the data sources is performed in real-time or periodically according to each step, state or context change in the medical system. Processing the search results comprises analyzing a search result reference and defining a reference context. The reference context fields are chosen from the pre-identified feature set as pertaining and ranked for the given reference. Then the search results are analyzed for reference context content relevance to the system context and given a feature report along a feature set defined for the context, sorted into categories of interest for a given intervention and intervention progress, and ranked or ordered based on a ranking measure. One example of ranking measure includes a distance calculation that represents relevance. The distance calculation is between the current system context form and the reference context form, and enables ranking the search outputs. Availability of reference measures for a given context enable the ranking of a set of references, and also the definition of a probability measure as a function of a universe of references for a given feature.

The selected results data set 272 is then sent to block 280 for presentation to the user. The types of information can be segmented into a tabbed display with a plurality of individual reference links listed under each tab. The user may click on any link to review contents in a browser window that is positioned minimally on the display or optionally enlarged to review greater amounts of information at a time. At least part of the analyzed search results is thus presented to the user as a function of the relevance score and number of available references in the search output.

In addition, in specific embodiments the information system functionality 200 includes a capability to connect to a hospital information system to suggest or automatically place orders for medical supplies for the lab when inventory is low.

In addition, contextually relevant production information and advertising may be presented to the medical information system user at any time based upon the system context and/or the fee paid by an advertiser. The advertising typically is associated to specific sources of input or search parameters which outline medical situations for which it should be displayed. The advertising can be paid to the browser provider according to a number of models including pay-per-view and pay-per-click. The advertising can also include rich content which interactively updates when played in the browser window. A plurality of links may be included with the advertising to allow the user to seek more information or place an order for a product, as for instance in the context of a procedure review and subsequent planning.

Accordingly embodiments of this invention enable new modes of delivering contextually relevant information into hospitals, offices and other similar environments through a medical information system which is installed in the medical environment with a browser or search engine delivering real-time, contextually relevant medical information and advertising.

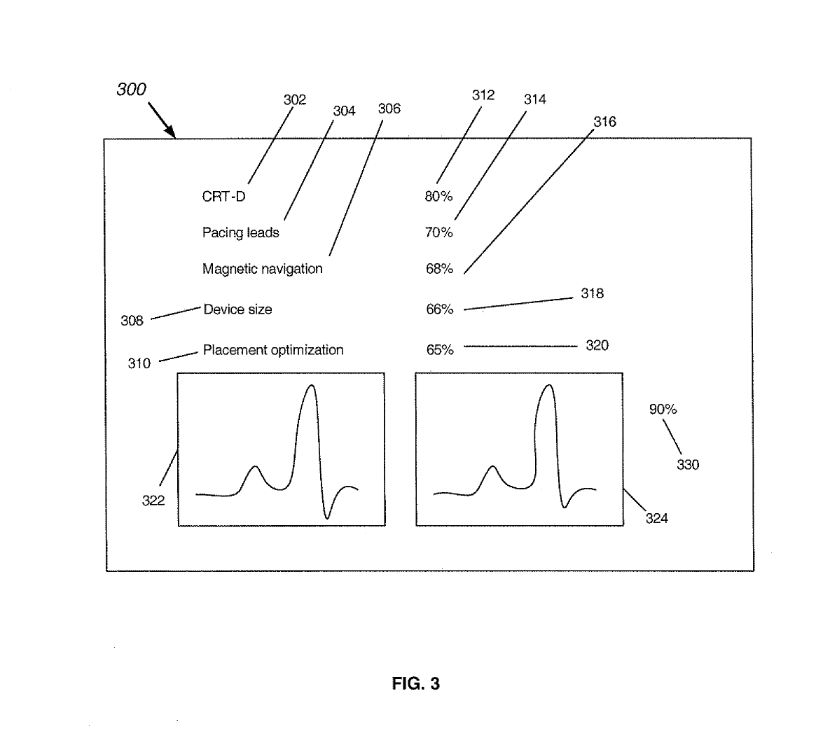

To further illustrate aspects of the invention, cardiac resynchronization therapy (CRT) is a proven treatment for selected patients with heart failure-induced electrical conduction disturbances and ventricular dyssynchrony. CRT uses a special pacemaker to re-coordinate the action of the right and left ventricles in patients with heart failure. In about 30% of patients with heart failure an abnormality in the heart's electrical conducting system (called an “intra-ventricular conduction delay or bundle branch block) causes the two ventricles to beat in an asynchronous fashion. CRT re-coordinates the beating of the two ventricles by pacing both ventricles simultaneously (as compared to typical pacemakers which pace only the right ventricle). CRT is administered using a pacemaker, called a CRT-P, or an implantable cardioverter defibrillator (ICD) with bradycardia pacing capabilities, called a CRT-D. The device comprises a third pacing lead added to help stimulate the heart's left ventricle. CRT stimulates both of the heart's ventricles so that they are more efficient in pumping blood to the body. FIG. 3 presents a typical example of a set of search parameters that could arise from a CTR procedure in a patient. As described above, the search parameter set depends from an analysis of the current system context, and as such varies from patient to patient, physician to physician, and procedure to procedure; no two such interventions are likely to lead to the exact same search parameter set. Further, the search parameter set evolves with the procedure progress. The set illustrated in FIG. 3 contains both (i) ranked field entries 302, 304, 306, 308, and 310, with text and relevance scores 312, 314, 316, 318, and 320, and (ii) graphics. In the example of the figure, the graphics 322 and 324 show ECG data collected at various locations, and an associated relevance score 330. In specific embodiments of the invention, the search parameter form also comprises image data, extracted image features, diagnostic features, and other such information as known in the art.

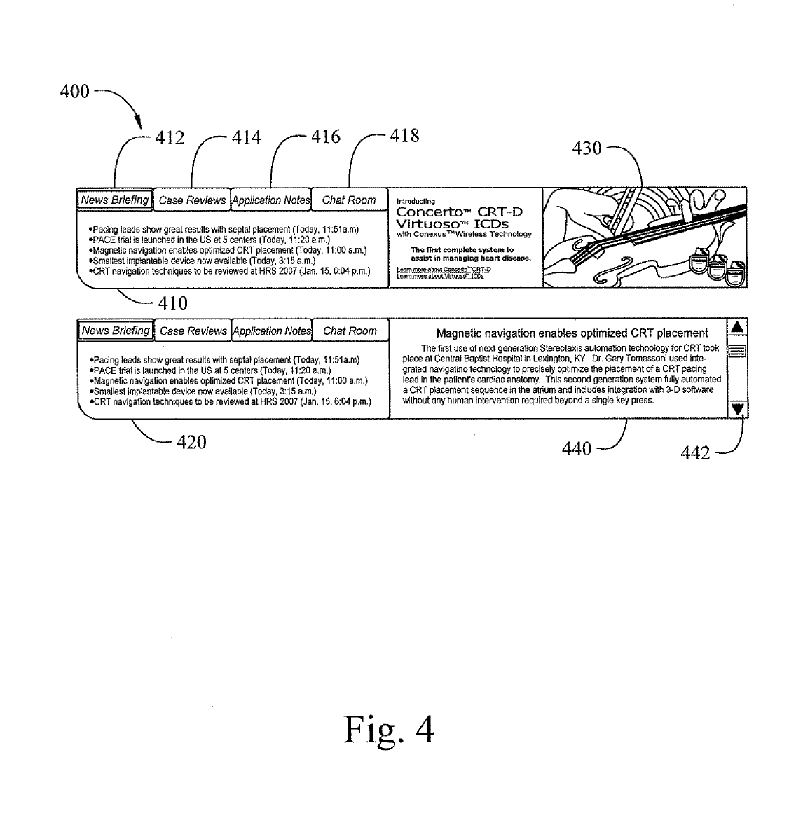

FIG. 4 describes a graphical user interface display 400 according to the principles of the present invention. The display presents four distinct areas; area 410 comprises a tabbed interface with tabs “News Briefing,” 412, “Case Reviews,” 414, “Application Notes,” 416, and “Chat Room,” 418. These various tabs are accessible by a mouse click and lead the user to the respective information types that have been determined by the information system to be of most relevance to the present medical system intervention. Area 420 is similar to 410 but enables user interface by clicking on any of the listed reference entries. Upon the user clicking on the bold typeface entry “Magnetic navigation enables optimized CRT placement (Today: 11:00 am),” that particular reference is displayed to the right in area 440. Area 440 comprises sliding cursor 442 that enables browsing through the entire contents of the reference. In one embodiment, clicking on area 440 brings up a larger display area containing the reference. Finally, area 430 presents an advertisement for a product of relevance to the present medical system intervention context, in the case of FIG. 4 an advertisement for an implantable cardioverter defibrillator (ICD) to be used in CRT; a CRT-D uses a defibrillator with bradycardia pacing capabilities. As indicated in this example the devices advertised in area 430 utilize wireless technology.

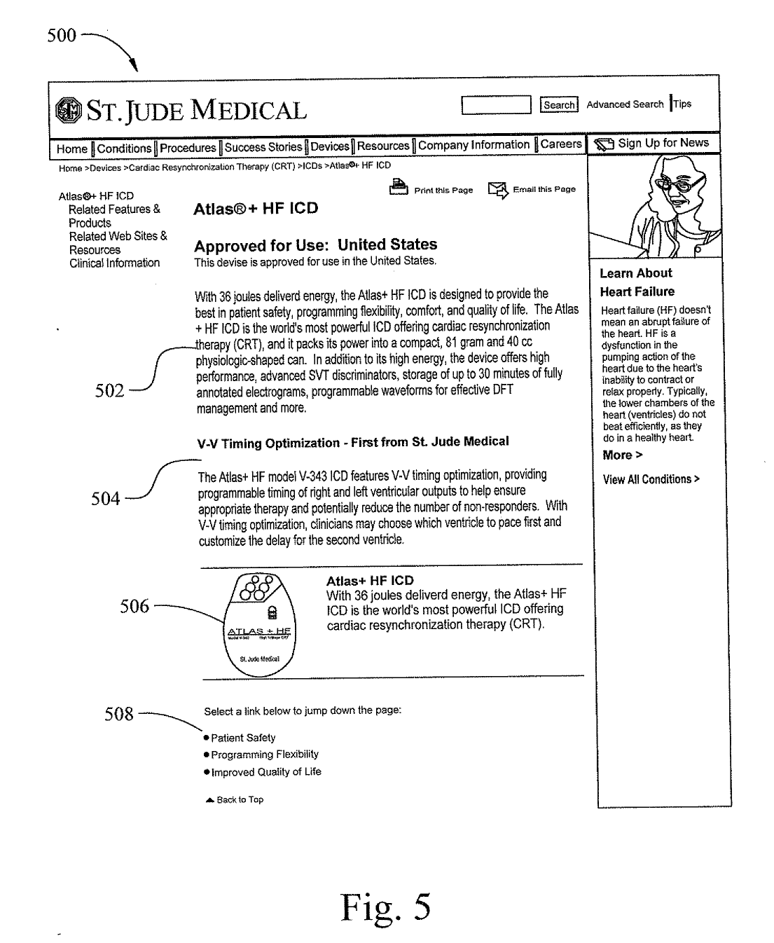

FIG. 5 presents in more details a search reference. The reference outlines one of the search form field contents that led to a match in the search, “cardiac resynchronization therapy” 502, and presents information relevant to a CRT intervention. In this instance, the reference presents specification information 504 for a device 506 suitable for CRT interventions; the reference also includes links 508 to access additional relevant information.

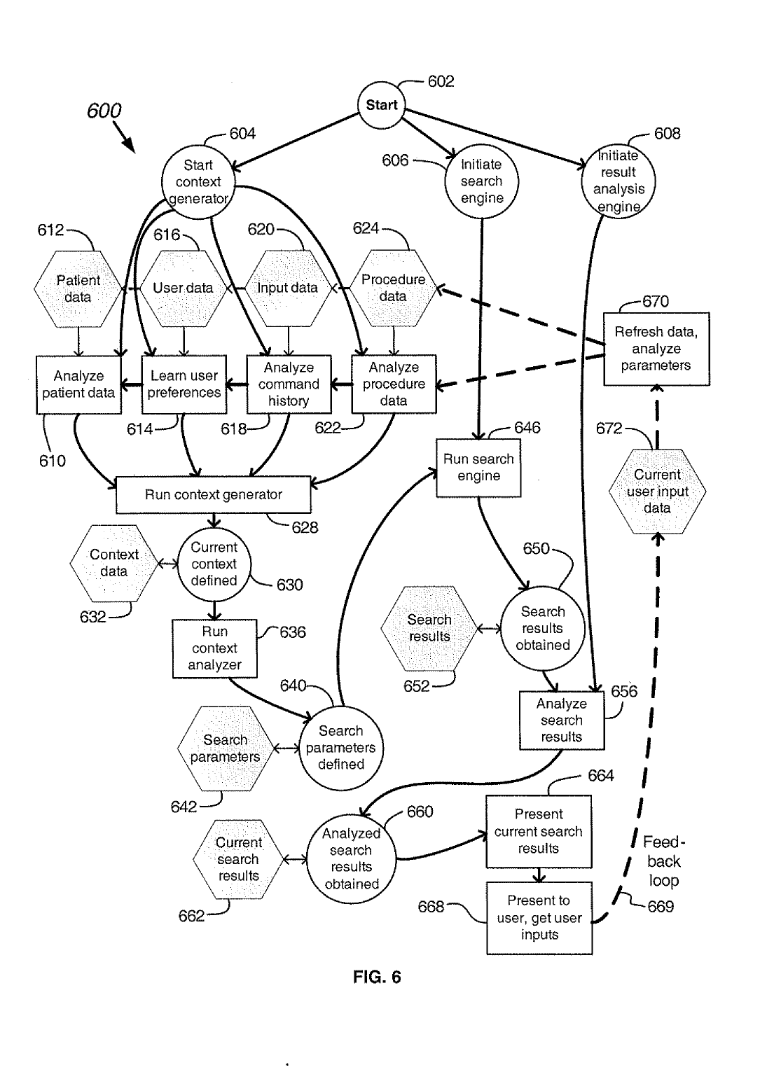

The operation of the context-relevant information system is illustrated in FIG. 6. Upon the start of a procedure, 602, the context generator engine 604 is started, and the search engine 606 and result analysis engine 608 are initiated. The start of the context generator 604 in turn triggers the various analysis blocks comprising the patient data analysis block 610, the user preference learning block 614, the command and input analysis block 618, and the procedure analysis block 622 to run their software instructions. These block instructions rely on available data including patient data 612, user data 616, input data 120, and procedure related data 624 and the software components associated with each block generate outputs that are processed by context generator block 628 to define the current context, 630, and associated context data 632. These context data 632 are input to the context analyzer engine 636 that in turn defines a set of current search parameters 642. These search parameters 642 are input to the search engine 646 that generates a current search 650 and associated search results 652. The search result analysis block 656 generates an output set of results 662 ranked for relevance and importance which are then presented to the user, 664. The actions 668 taken by the user in part as a result of availability of these ordered results through feedback loop 669 become part of the current user input data set 672, and these inputs are used to refresh the various input data sets available to the information system, blocks 612, 616, 620, and 624, but also can modify the parameters of the various software blocks that iteratively define moment-by-moment the current system context, blocks 610, 614, 618, and 622. Thus by monitoring the system state over time and monitoring the user inputs a new, updated, system context is defined that then leads to a new search, and as a results and updated set of results presented to the user. The information search engine monitors the system during the entire procedure, iteratively providing time-critical and context-relevant data to the user(s) of the interventional medical system 100.

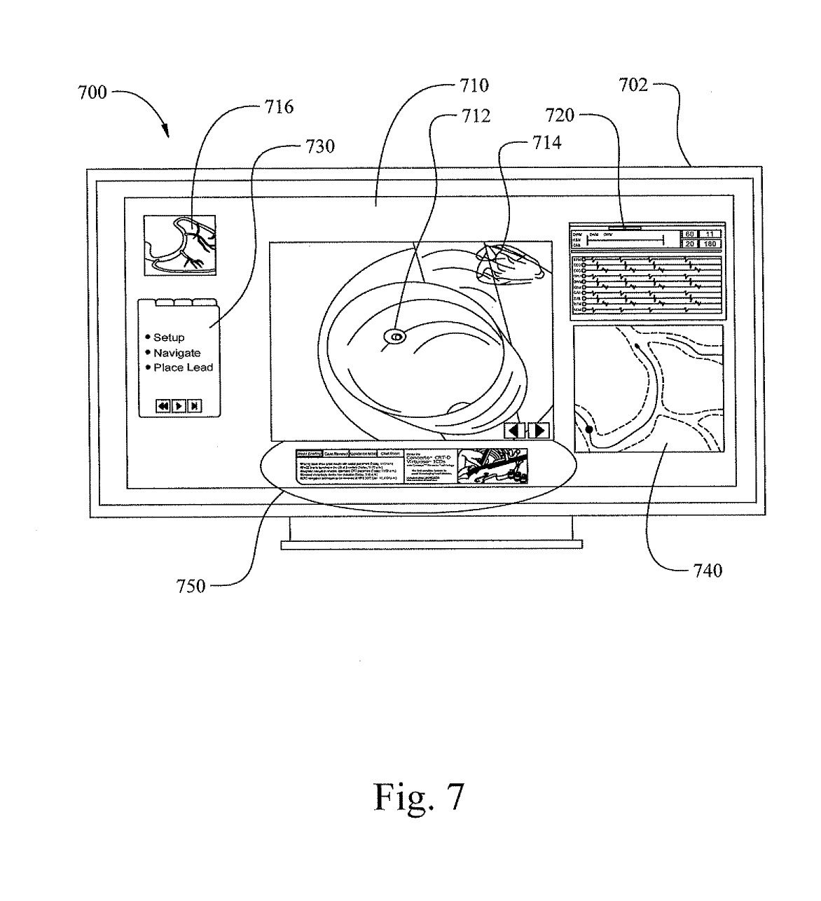

FIG. 7 presents one embodiment 700 of the display and user interface part of the present invention 180, the presented embodiment being applied to CRT. A composite display 702 presents information from a multiplicity of medical systems, including a three-dimensional surface rendition of the vasculature of interest 710, with diagnostic information 712 superimposed thereon, a 3D representation of the coronary arteries, 714, and a model of a vessel of interest 716. Additionally, an ECG trace 720 is displayed, as well as a dynamic x-ray projection image sequence 740 showing the progress of an interventional device within the patient's body lumen. The information system user interface 750 described in FIG. 4 is also displayed to the user so as to enable real-time presentation of context-relevant information, allowing the user to click on any of the listed references to bring about a more detailed and extensive presentation of contents.

The advantages of the above described embodiments and improvements should be readily apparent to one skilled in the art, as to enabling the real-time presentation of context-relevant information to a user of an interventional medical system. Additional design considerations may be incorporated without departing from the spirit and scope of the invention. Accordingly, it is not intended that the invention be limited by the particular embodiments or forms described above, but by the appended claims.

What is claimed is:

1. An automated method of searching for and providing contextually relevant medical information to a user of a procedure-supporting medical system, the method comprising:
gathering procedure status information to define a current medical system context;
processing the medical system context in preparation for searching for relevant information in a set of electronic information sources;
searching a set of information sources based at least in part on processed system context; and
presenting to the user at least part of the search results, wherein at least one of the gathering, processing, searching, and presenting is done during the procedure.

2. The method of claim 1, further comprising processing the search results prior to presenting.

3. The method of claim 1, wherein gathering procedure status information comprises accounting for patient information data.

4. The method of claim 3, wherein the patient information data comprises a diagnostic record.

5. The method of claim 1, wherein gathering procedure status comprises utilizing the user's preferences.

6. The method of claim 5, wherein utilizing the user's preferences further comprises learning the user's preferences over a plurality of procedures performed using the medical system.

7. The method of claim 1, wherein at least one of processing the medical system context and searching a set of information sources comprises sending data to a remote site; the remote site processing the sent data and generating output results; wherein at least one of processing the medical system context and searching a set of information sources is performed during the procedure.

8. The method of claim 7, wherein the remote site automatically processes the data;

9. The method of claim 7, wherein processing the sent data at the remote site comprises a human interpreting the sent data and generating output data based on said interpretation.

10. The method of claim 1, wherein the data generated during a procedure comprises at least one of an ECG data set, a medical image data set, an electrical activity data set, a vital sign data set, a blood pressure data set, an oximetry data set, a hemodynamics data set.

11. The method of claim 1, wherein the user information comprises at least one of a procedure type, a device type, a drug, an anatomy type, user selection criteria.

12. The method of claim 1, wherein processing the medical system context comprises generating a parameter set.

13. The method of claim 12, wherein a parameter set comprises a keyword set.

14. The method of claim 12, wherein a parameter set comprises a numerical range.

15. The method of claim 1, wherein performing a search in a set of information sources comprises performing a search selected from the group consisting of a parameter search, and a feature search.

16. The method of claim 1, wherein the set of information sources comprises at least one of a local database, a remote database, an intranet site, an internet site.

17. The method of claim 1, wherein the set of information sources contains information types, the information types comprising at least one of a published article, a patent, a patent application, an intranet file, an advertisement, a book, a presentation record, a news release, an information data sheet, a marketing brochure, a product specification.

18. The method of claim 1, wherein presenting to the user at least part of the search results comprises generating a tabbed display with a plurality of reference links.

19. A method of conducting a procedure with a medical system using context relevant information, comprising:
gathering relevant medical procedure context;
searching a database for procedure-related data; and
displaying the procedure-related data to a user of the medical system, wherein at least one of the gathering, searching, and
displaying is performed during the procedure.

20. The method of claim 19, further comprising updating the database.
